(19) United States
(12) Patent Application Publication
(10) Pub. No.: US 2020/0108710 A1
(43) Pub. Date: Apr. 9, 2020

(54) VENTILATION DEVICE FOR A MOTOR VEHICLE

(71) Applicant: Valeo Systemes Thermiques, Le Mesnil Saint Denis Cedex (FR)

(72) Inventors: Kamel Azzouz, Le Mesnil Saint Denis Cedex (FR); Michael Lissner, Le Mesnil Saint Denis Cedex (FR); Sébastien Garnier, Le Mesnil Saint Denis Cedex (FR); Julien Tissot, Le Mesnil Saint Denis Cedex (FR); Amrid Mammeri, Le Mesnil Saint Denis Cedex (FR)

(73) Assignee: Valeo Systemes Thermiques, Le Mesnil Saint Denis Cedex (FR)

(21) Appl. No.: 16/621,002

(22) PCT Filed: Jun. 11, 2018
(86) PCT No.: PCT/EP2018/065369

§ 371 Date: Dec. 10, 2019

(30) Foreign Application Priority Data
Jun. 12, 2017 (FR) 1755243

(51) Int. Cl. B60K 11/08; B60K 11/06

(52) U.S. Cl. CPC B60K 11/085; B60K 11/06

(57) ABSTRACT

The invention relates to a ventilation device intended to generate an air flow in the direction of a motor vehicle heat exchanger, comprising:
spaced-apart ducts,
at least one air manifold having orifices, each duct leading at one of its extremities into a separate orifice of the air manifold,
   each duct being provided with at least one opening for ejecting an air flow passing through said duct, the opening being separate from the extremities thereof and situated outside the air manifold,
   at least one duct being mounted so as to be orientable between a closed position and an open position, the device being configured to allow more air to pass through in the open position than in the closed position.

The present invention relates to a ventilation device for a motor vehicle.

The front face of a motor vehicle generally has a motor/fan unit provided with heat exchangers. A heat exchanger usually comprises tubes carrying a heat transfer fluid, and heat exchanger elements, known as “fins” or “inserts”, that are connected to these tubes and make it possible to increase the heat exchange surface area between the tubes and the ambient air.

In order to increase the exchange of heat between the heat transfer fluid and the ambient air, a blower wheel is very often used to generate an air flow directed toward the tubes and the fins. However, the drive means for such a blower wheel generally consume a large amount of energy. Moreover, since the air flow generated by the blades is circular, the exchange of heat is not uniform over the entire surface of the tubes and the fins. Furthermore, when it is not necessary to start up the ventilation device, in particular when the exchange of heat with the non-accelerated ambient air is sufficient to cool the heat transfer fluid, the blades obstruct the flow of the ambient air toward the tubes and the fins, thereby limiting the exchange of heat. Finally, for thermal management purposes, it may be advantageous, by contrast, to be able to limit the heat exchange between the tubes and the ambient air.

The aim of the invention is to remedy these drawbacks.

To this end, the invention relates to a ventilation device intended to generate an air flow in the direction of a motor vehicle heat exchanger, comprising spaced-apart tubes, known as aerodynamic tubes, at least one manifold having orifices, each tube leading at one of its extremities into a separate orifice of the manifold, each aerodynamic tube being provided with at least one opening that is separate from the extremities thereof and situated outside the manifold, at least one aerodynamic tube being mounted so as to be orientable between a closed position and an open position, the device being configured to allow more air to pass through in the open position than in the closed position.

The ventilation device according to the invention advantageously provides a function of shutting off the air inlet and a function of ventilating heat exchangers in a compact space allowing better thermal management of a motor vehicle.

Advantageously according to the invention, the device makes it possible to vary the flow rate of air that passes through each air inlet in which the device is mounted and that arrives at the heat exchangers, depending on the orientation of the orientable duct(s). It is thus possible to optimize the thermal management of these heat exchangers as required, as explained in more detail below.

Moreover, for equal heat exchange capacities, the volume taken up by a ventilation device according to the invention is less than that of a conventional blower-wheel ventilation device. Furthermore, again with equal heat exchange capacities, the flow rate of blown air required with a ventilation device according to the invention is lower than with a conventional blower-wheel ventilation device.

Finally, it will be immediately understood that the device advantageously makes it possible to provide uniform flow by virtue of said ducts, in contrast to a blower wheel, the blades of which generate a circular flow, and to not block, in the open position of the duct(s), the flow of ambient air toward the tubes and the fins of the heat exchanger when the ventilation device is off, in contrast to a blower wheel, the immobile blades of which limit the flow rate of air toward the heat exchanger and thus the exchange of heat therewith.

According to further optional embodiment features of the invention:
at least two ducts are mounted in an orientable manner and are configured to be transferred into the closed position and into the open position independently of one another,
all the ducts are mounted in an orientable manner,
the ducts are positioned relative to one another so as to block an air flow in the closed position and so as to allow an air flow to circulate in the open position,
the ducts are substantially rectilinear tubes that are mutually parallel and aligned so as to form a row of tubes,
the device comprises means for controlling the orientation of each orientable duct,
the control means comprise an actuator and/or a linkage,
each duct has a section comprising a leading edge, a trailing edge on the opposite side from the leading edge, a first and a second profile that each extend between the leading edge and the trailing edge, said at least one opening in the duct being in one of the first and second profiles, said at least one opening being configured such that an air flow exiting the opening flows along at least a portion of said one of the first and second profiles,
said at least one opening is a slot extending along at least 90% of the length of each duct,
said at least one opening is delimited by lips, the spacing of which is between 0.5 mm and 2 mm,
two adjacent ducts are disposed opposite one another such that the openings are made in the facing profiles,
said at least one duct has a first opening that leads into the first profile and a second opening that leads into the second profile.

A further subject of the invention is a heat exchange module for a motor vehicle, comprising a ventilation device as described above and a heat exchanger, the ventilation device and the heat exchanger being positioned relative to one another such that an air flow set in motion by the ventilation device supplies the heat exchanger with air.

Embodiments of the invention will now be presented that are given by way of nonlimiting examples and with reference to the appended figures, in which:

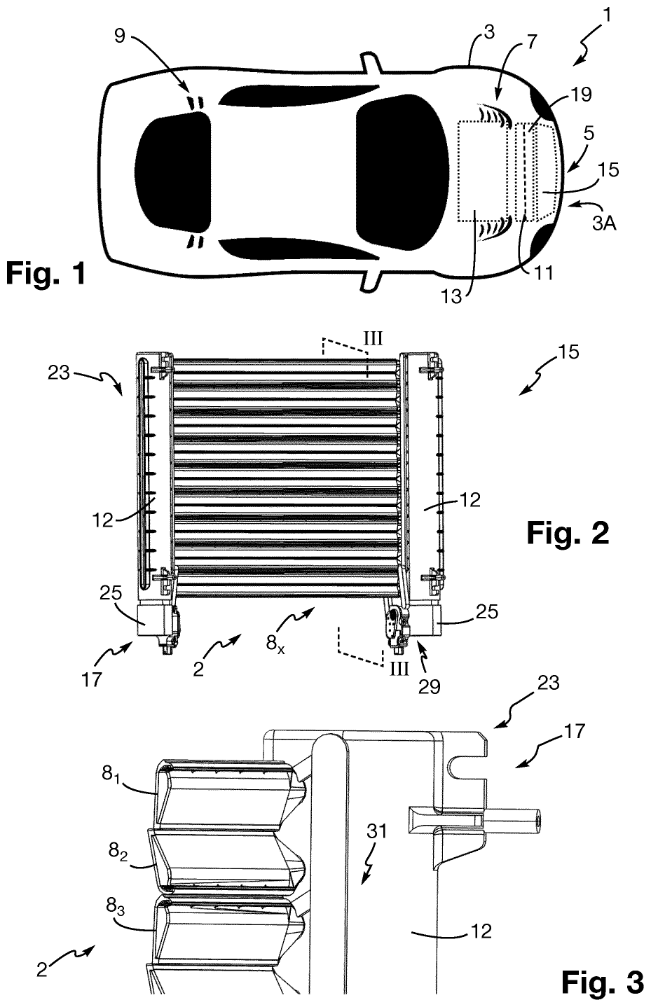

FIG. 1 is a schematic top view depiction of a motor vehicle;

FIG. 2 is a perspective view of a ventilation device according to a first embodiment of the invention in the closed position;

FIG. 3 is a partial view of FIG. 2, the device being in section on the plane III-III;

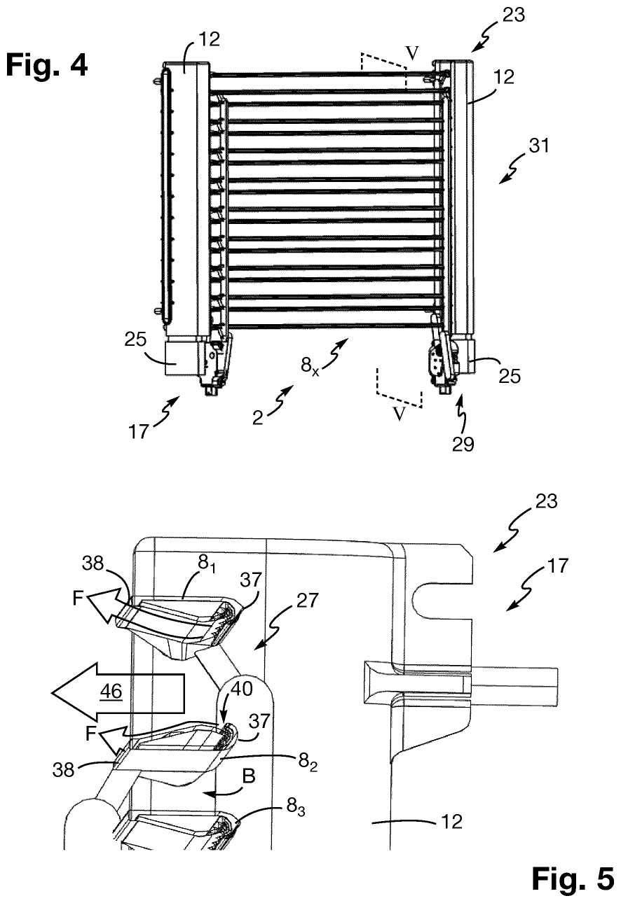

FIG. 4 is a perspective view of the device in FIG. 2 in the open position;

FIG. 5 is a partial view of FIG. 4, the device being in section on the plane V-V in FIG. 4;

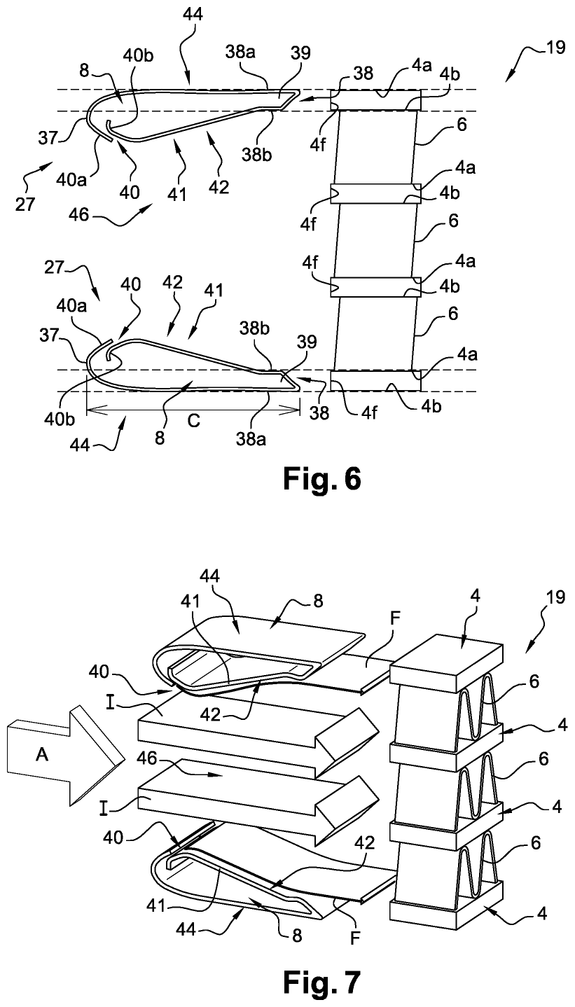

FIG. 6 is a schematic view in section of aerodynamic tubes according to the first embodiment and of a heat exchanger;

FIG. 7 is a schematic perspective view of aerodynamic tubes according to the first embodiment and of a heat exchanger;

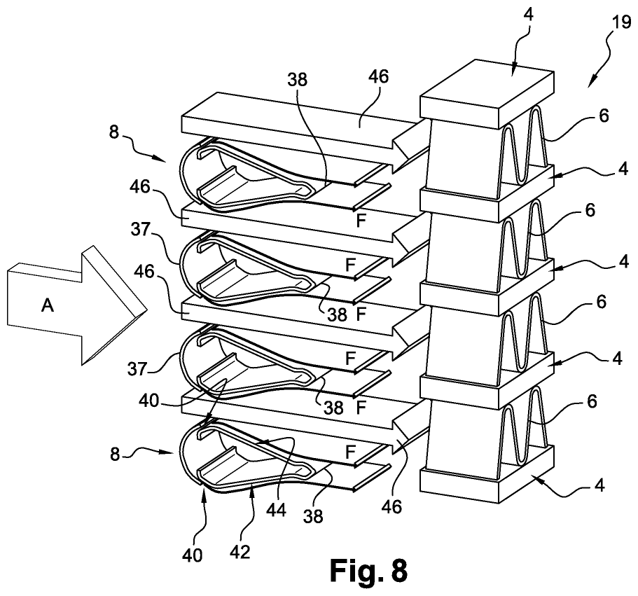

FIG. 8 is a schematic perspective view of aerodynamic tubes and of a heat exchanger according to a second embodiment of the invention; and

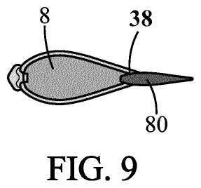

FIG. 9 illustrates an aerodynamic tube according to an embodiment variant of the invention.

In the various figures, identical or similar elements bear the same references. Therefore, the description of the structure and function thereof will not be systematically repeated.

As illustrated in FIG. 1, a motor vehicle 1 has a body 3 provided with at least one intake opening 5, 7, 9 for supplying air, while the motor vehicle 1 is moving, to at least one thermal device 11 having for example at least one heat exchanger 19. As explained above, the intake opening 5, generally known as the grille, is the most common and forms an opening on the front face 3A of the motor vehicle 1. For this reason, the explanation below will be given on the basis of this intake opening 5.

Of course, depending on the location of the engine 13 and/or of the thermal device 11 in the motor vehicle 1, it will be understood that the invention would be applicable with the same results and the same advantages to other intake openings such as those 7 and 9 illustrated in FIG. 1, which are located on the hood and the quarter panels, respectively.

The invention relates to a ventilation device 15 notably intended to be mounted on an air intake opening 5, which, as will be described in more detail below, is not a motor/fan unit generally used for motor vehicles.

Specifically, advantageously according to the invention, the ventilation device does not have a blower wheel for generating a forced air flow, that is to say including when the motor vehicle is not on the move.

A further subject of the invention is a heat exchange module comprising the ventilation device 15 and a thermal device 11.

Thus, the thermal device 11 can have at least one heat exchanger 19, for example the one used for the air conditioning of the passenger compartment, the one used for cooling the engine 13, the one used for cooling accumulator batteries, the one used for cooling the power electronics circuits, or the one used for cooling the charge air of the turbocompressor of the engine 13.

The ventilation device 15 and the thermal device 11 are positioned relative to one another such that the ventilation device 15 supplies air to the heat exchanger(s) of the thermal device 11.

As illustrated in FIGS. 6 and 7, a heat exchanger 19 comprises coolant tubes 4 which carry a fluid such as water, coolant or a refrigerant or air by pumping. Generally, the coolant tubes 4 are substantially rectilinear, mutually parallel so as to form a row, and extend over the width or height of the motor vehicle 1.

As is conventional in a motor vehicle heat exchanger 19, each coolant tube 4 has a substantially elongate section delimited by a first wall 4a and a second wall 4b that are substantially planar and are connected to heat exchange fins 6.

As can be seen in the figures, the ventilation device 15 has primarily a ventilation device 2 and an aerodynamic modification device 17. As can be seen more clearly in FIGS. 3,5 and 7, the ventilation device 2 according to a first embodiment of the invention comprises at least one duct 8, which, in the same way as the coolant tubes 4, are substantially rectilinear, mutually parallel, and aligned so as to form a row of aerodynamic tubes 8. However, other forms of duct are conceivable.

Preferably, the coolant tubes 4 and the aerodynamic tubes 8 are all mutually parallel. Thus, the rows of aerodynamic tubes 8 and of coolant tubes 4 are themselves parallel. Moreover, the aerodynamic tubes 8 are disposed such that each of them is located opposite a coolant tube 4.

The number of aerodynamic tubes 8 is adapted to the number of coolant tubes 4. For example, for a conventional heat exchanger 19, the ventilation device 2 could comprise for example between 10 and 70 aerodynamic tubes 8, preferably between 15 and 25 aerodynamic tubes 8 for a heat exchanger having between 40 and 70 coolant tubes 4.

In order to limit the volume taken up by the assembly made up of the heat exchanger 19 and the ventilation device 2 while obtaining a heat exchange performance similar to that of a blower-wheel ventilation device, the row of aerodynamic tubes 8 is disposed at a distance of less than 100 mm from the row of coolant tubes 4, this distance being preferably between 10 mm and 50 mm.

In addition, the height of the row of aerodynamic tubes 8 will preferably be equal to or less than the height of the row of coolant tubes 4. For example, with the height of the row of coolant tubes 4 being 400 mm, the height of the row of aerodynamic tubes 8 will be substantially equal to or less than this value.

The ventilation device 2 also comprises air intake means 23 that are intended to feed air to the cavity of the aerodynamic tubes 8. These intake means 23 preferably comprise two manifolds 12, disposed at two opposite ends of the ventilation device 2. Specifically, as can be seen in FIGS. 2 and 4, the aerodynamic tubes 8 are, preferably, connected at each of their extremities to one of the manifolds 12 in order to make the ventilation of each of the aerodynamic tubes 8 uniform. Preferably, each manifold 12 is made of aluminum, polymer material or polyamide, preferably PA66.

In order to simplify manufacture and compactness, the manifolds 12 could also be used for the fluid of the coolant tubes 4, in which case there is a manifold known as a “bi-fluid” manifold. Since the circulation of fluid in a motor vehicle heat exchanger is well known, it will not be described further below.

As illustrated in FIGS. 2 and 4, the air intake means 23 have, for each manifold 12, a turbomachine 25 incorporated into the associated air manifold 12 thereof. The turbomachine may be a fan of the centrifugal, axial or helical type or any other type of compact fan. Alternatively, it is also possible to separate the turbomachine 25 from the manifold 12 thereof or even for there to be a single remote turbomachine 25 for feeding the two manifolds 12.

In the example illustrated in FIGS. 3 and 5 to 7, it is apparent that each aerodynamic tube 8 has a section comprising a substantially parabolic free leading edge 37 from which there extend a first profile 42 and a second profile 44, which meet at a trailing edge 38 disposed next to a heat exchanger 19 of the thermal device 11. The shape of the aerodynamic tubes 8 advantageously allows manufacture which can be obtained, for example, by bending a metal sheet, such as an aluminum-based sheet, or by 3D printing of metal or plastic. In the case of plastics material, the aerodynamic tubes can be manufactured by molding, overmolding, or any other manufacturing process involving plastics materials.

By way of nonlimiting example, the chord c of the section, or the width of the aerodynamic tube 8, can be between 30 mm and 50 mm. Furthermore, the leading edge 37 may have a height of between 10 mm and 20 mm.

In these FIGS. 3 and 5 to 7, it is apparent that each aerodynamic tube 8 has at least one opening 40 provided close to the leading edge 37, which forms air spraying means 7 of the ventilation device 2. As explained in more detail below, said at least one opening and said profile of each aerodynamic tube 8 are designed such that the air F sprayed from each opening 40 entrains a part I of the air A that is present around each opening 40 in order to create the air flow 46 of the ventilation device 2.

More specifically, said at least one opening 40 is configured such that the air carried by the air intake means 23 in the cavity of the aerodynamic tube 8 is ejected through said at least one opening 40. To this end, each opening 40 is disposed opposite the heat exchanger 19. Thus, each opening 40 is disposed in a manner facing the frontal wall 4f connecting the first 4a and second 4b flat walls of a corresponding coolant tube 4. Preferably, each opening 40 is configured such that the air flow 46 is ejected substantially perpendicularly to the direction of the length of the aerodynamic tubes 8.

It will be noted that each opening 40 is separate from the extremities of the aerodynamic tube 8.

It will also be noted that each opening 40 is situated outside the manifold(s) 12.

Preferably according to the invention, each opening is in the form of a slot making it possible to form an air flow 46 of large dimensions in the direction of the heat exchanger 19 without excessively reducing the mechanical strength of the aerodynamic tubes 8. Consequently, to obtain the largest possible air passage, the openings 40 extend advantageously along a major part of the length of the aerodynamic tubes 8, preferably along at least 90%.

As can be seen more clearly in FIGS. 5 to 7, each opening 40 is delimited by a distal lip 40a and a proximal lip 40b. The distal lip 40a is an extension of the leading edge 37 while the proximal lip 40b is an extension of a curved part of the profile 42. By way of example, the thickness of the opening 40, that is to say the distance between the distal lip 40a and proximal lip 40b, can be between 0.5 mm and 2 mm.

Thus, in the first embodiment of the invention in which the aerodynamic tubes 8 have only one opening 40, the aerodynamic tubes 8 function in pairs of aerodynamic tubes 8 that are identical but oriented differently. Preferably, according to the first embodiment, each aerodynamic tube 8 of a pair is symmetric with respect to the desired air flow 46 of the ventilation device 2, that is to say exhibits “mirror” axial symmetry with respect to the air flow 46. In the first embodiment illustrated in FIGS. 5 to 7, each opening 40 opens out at the profile 42 of the section, the profiles 42 of a pair facing one another. Of course, the opening 40 can open out either at the profile 44 or at the profile 42.

Thus, the air flows F ejected through the openings 40 flow at least partially along a tube surface portion, by the Coandă effect, thereby creating an air flow 46 in which a drawn-in part I of the ambient air A is entrained as illustrated in FIGS. 5 and 7. It will be recalled that the Coandă effect is an aerodynamic effect in which a fluid flowing along a surface at a short distance therefrom tends to run along said surface, or to be entrained.

Exploiting this effect, the invention makes it possible, by virtue of the entrainment of the ambient air A in the air flow 46 thus created, to obtain a flow rate of air sent toward the heat exchanger 19 of the thermal device 11 that is substantially identical to that generated by a conventional blower-wheel fan but consumes less energy. Specifically, the air flow 46 of the ventilation device 2 is the sum of the air flow F ejected by the openings 40 and that I of the entrained ambient air A.

In the first embodiment, which can be seen in FIG. 6, the trailing edge 38 of each aerodynamic tube 8 comprises a trailing edge portion 39 delimited by a first trailing edge wall 38a and a second trailing edge wall 38b that are substantially parallel. Specifically, in order to optimize ventilation, the distance between the first trailing edge wall 38a and the second trailing edge wall 38b is designed to correspond to the height of the frontal face 4f of a coolant tube 4, as indicated by dashed lines in FIG. 6. It will be understood that the air flow 46 can thus cross a maximum surface area of the fins 6 in order to optimize heat exchange. Of course, other types of trailing edge 38 are conceivable.

In the first embodiment of the invention, two rows of coolant tubes 4 and three rows of fins 6 are contained in the volume delimited by the two aerodynamic tubes 8 of one and the same pair. Of course, the number of each row does not have to be limited to two and three. Thus, the air flow 46 between the two aerodynamic tubes 8 could face more or fewer than two rows of coolant tubes 4 and/or more or fewer than three rows of fins 6. By way of example, it is thus conceivable for the space between the two aerodynamic tubes 8 to ventilate a single row of fins 6.

According to a second embodiment of the invention, illustrated in FIG. 8, the aerodynamic tubes 8 each have two openings 40. This second embodiment is particularly advantageous for maximizing the air flow 46 of the ventilation device 2. Specifically, as can be seen in FIG. 5, between each pair of aerodynamic tubes 8 in the open position in the first embodiment, there is a gap B in which there is no ventilation. This gap B consequently forms a “dead” zone.

Advantageously according to the invention, the second embodiment therefore proposes blowing both over the profile 42 and over the profile 44 in order for there to be no “dead” zone. As can be seen in FIG. 8, the section of each aerodynamic tube 8 is substantially symmetric with respect to the width of the aerodynamic tube 8. It will be understood in particular that the profiles 42 and 44 afford symmetric curvatures with “mirror” axial symmetry with respect to the width of the aerodynamic tube 8.

According to the second embodiment, a first opening 40 thus opens out at the first profile 42 and a second opening 40 opens out at the profile 44. These openings 40 are similar to those of the first embodiment with the same results and advantages. Consequently, as can be seen in FIG. 8, the air flow 46 entraining the ambient air A is created between each adjacent aerodynamic tube 8 and no longer just between each pair, as in the first embodiment.

Irrespective of the embodiment of aerodynamic tubes 8, the device 15 also has an aerodynamic modification device 17 intended to selectively modify the inclination of all or some of the aerodynamic tubes 8 of the device 15 between an open position illustrated in FIG. 4 and a closed position illustrated in FIG. 2.

More specifically, at least one of the tubes 8 is mounted so as to be orientable between a closed position and an open position, the ventilation device being configured to allow more air to pass through in the open position than in the closed position.

In the closed position, there is a space between the orientable tube and the aerodynamic tube(s) adjacent thereto, which is smaller than a space between the orientable tube and the aerodynamic tube(s) adjacent thereto in the open position.

In the embodiments illustrated, all the tubes 8 are mounted in a pivotable manner.

In the embodiments illustrated, the tubes 8 are positioned relative to one another so as to block an air flow in the closed position and so as to allow an air flow to circulate in the open position.

Thus, the ventilation device according to the invention has a function of shutting off the air inlet and a function of ventilating the heat exchangers in a compact space, allowing better thermal management of a motor vehicle, since the grille is a blower.

Depending on the orientation of the tubes, the device makes it possible vary the flow rate of air that arrives at the heat exchanger, thereby also making it possible to optimize the efficiency of the heat exchanger.

The closed position is particularly advantageous when the vehicle is traveling, in particular a high speed, since, in this position, the coefficient of drag of the vehicle is reduced and the aerodynamics thereof are improved.

The open position is particularly advantageous when the vehicle is at a standstill, since, in this position, the aeration of the engine compartment is improved.

In the example illustrated in FIGS. 2 to 5, the aerodynamic modification device 17 uses manifolds 12 as frames between which 18 aerodynamic tubes 8 are installed.

It will be noted that, in the open position of the aerodynamic modification device 17, which is illustrated in FIGS. 4 and 5, the aerodynamic tubes 8ₓ, 8₁, 8₂, 8₃ form substantially parallel slats in the manner of a Venetian blind. Conversely, in the closed position of the aerodynamic modification device 17, which is illustrated in FIGS. 2 and 3, the aerodynamic tubes 8ₓ, 8₁, 8₂, 8₃ form oblique slats, the adjacent slats being in contact with one another to prevent any passage of air.

Preferably, the aerodynamic modification device 17 has displacement means 29 that are intended to pivot all or some of the 18 aerodynamic tubes 8ₓ between the manifolds 12. Specifically, depending on the function and/or the thermal management and/or the aeraulic management of the motor vehicle 1, the partial or complete closure of at least one aerodynamic tube 8ₓ from an open position or, conversely, the partial or complete opening of at least one aerodynamic tube 8ₓ from a closed position can be brought about in order to finely control the air supply generated by the movement of the motor vehicle 1 plus (or not) that generated by the ventilation device 2 by maintaining a substantially uniform flow toward the thermal device 11.

As illustrated in FIGS. 2 to 5, the means 29 may have a linkage 31 provided with at least one arm and at least one rod, which is associated with a mechanical, electric or pneumatic actuator.

Furthermore, the aerodynamic tubes 8ₓ have suitable surface areas, thicknesses and geometries and are made of materials that are capable of withstanding the air pressure brought about by the speed of the vehicle 1, possibly plus a head wind speed, in particular when the aerodynamic tubes 8ₓ are in the closed position as illustrated in FIGS. 2 and 3.

Consequently, the device 15 according to the invention allows optimization of the thermal management of the heat exchangers 19 of the thermal device 11 compared with the use of a conventional blower wheel, the drive means of which consume a large amount of energy.

In addition, since the aerodynamic modification device 17 is incorporated in the aerodynamic tubes 8ₓ of the ventilation device 2, it is no longer necessary to use heat exchangers 19 provided with a ventilation blower wheel. The device 15 according to the invention thus takes up a smaller volume than a ventilation blower wheel and what is more has a selective shut-off function in addition.

It will also be understood that the device 15 advantageously makes it possible to provide laminar flow by virtue of the aerodynamic tubes 8ₓ, unlike a blower wheel, the blades of which generate turbulent flow.

Moreover, in the open position of the aerodynamic modification device 17, the device 15 leaves the flow of ambient air toward the tubes 4 and the fins 6 of the thermal device 11 entirely free when the ventilation device 2 is off, unlike a conventional blower wheel, the immobile blades of which limit the flow rate of air.

Finally, the device 15 affords the possibility of localizing the sprayed air of the ventilation device 2 by virtue of the selective tilting of the aerodynamic tubes 8ₓ, making it possible to provide ventilation only for certain parts of the heat exchangers 19, for example the one used for the air conditioning of the passenger compartment, the one used for cooling the engine 13, the one used for cooling accumulator batteries, the one used for cooling the power electronics circuits, or the one used for cooling the charge air of the turbocompressor of the engine 13.

Consequently, by way of nonlimiting example, advantageously according to the invention, upon start-up, all or some of the aerodynamic tubes 8ₓ can be in the closed position to make it possible to block the air inlet to the heat exchangers 19 of the thermal device 11 in order that the engine 13 heats up more quickly in order to reduce fuel consumption. When the motor vehicle is traveling, all the aerodynamic tubes 8ₓ can be in the open position and, optionally, the ventilation device 2 can be active, in order to make it possible to guide the air drawn in by the movement of the motor vehicle to the heat exchangers 19 of the thermal device 11. When the motor vehicle 1 is at a standstill with the engine 13 operating, all the aerodynamic tubes 8ₓ can be in the open position and the ventilation device 2 can be active in order to make it possible to maximize the air flow 46 to the heat exchangers 19 of the thermal device 11. Finally, above a predetermined speed, for example 100 km·h⁻¹, all the aerodynamic tubes 8ₓ can be in the closed position in order to improve the aerodynamics thereof and to reduce fuel consumption.

The aerodynamic tubes 8 are advantageously made of aluminum.

In this case, the ventilation device is obtained by brazing.

According to another variant, the aerodynamic tubes 8 are made of a plastics material such as polyamide (PA).

In this case, the ventilation device is advantageously obtained by injection-molding plastic.

According to an embodiment variant illustrated in FIG. 9, the ventilation device comprises a lip 80 overmolded on at least one aerodynamic tube, or on each aerodynamic tube 8.

The lip 80 is made of rubber.

As can be seen in FIG. 9, the lip 80 is overmolded on the trailing edge 38 of the associated aerodynamic tube 8.

The lip 80 is configured so as, in the closed position of the pivoting tube 8, to come into contact with an adjacent pivoting tube, thereby allowing leaktightness between the pivoting tube 8 in the closed position.

The invention is not limited to the embodiments presented, and other embodiments will become clearly apparent to a person skilled in the art. In particular, it is possible, depending on the type of intake opening 5, 7, 9 (location on the body, shape of the opening, etc.), the type of thermal device 11 (type of heat exchanger 19, shape of heat exchanger 19, etc.), the type of aerodynamic modification device 17 (more or fewer aerodynamic tubes 8ₓ, type of manifold 12, etc.) and the ventilation device 2 (type of intake means 23, etc.), for the geometry and number of aerodynamic tubes 8ₓ to be able to be modified without departing from the scope of the invention.

The aerodynamic tubes 8ₓ of the first and second embodiments could be combined. Thus, for example, aerodynamic tubes 8ₓ of the second embodiment could be interposed between a pair of aerodynamic tubes 8ₓ of the first embodiment.

It is also conceivable for all or some of the cavity of the aerodynamic tubes 8ₓ of the first and second embodiments to comprise means for guiding the air carried toward the opening(s) 40. Specifically, the air flow flows through the cavity of the aerodynamic tube 8ₓ along the length of the aerodynamic tube 8ₓ. These guide means would make it easier to divert the air flow in order to direct it toward the opening(s) 40. For example, these guide means could be in the form of at least one deflector formed integrally with the associated aerodynamic tube 8ₓ.

It will be noted that, advantageously, at least two aerodynamic tubes 8 are mounted in an orientable manner and are configured to be transferred into a closed position and into an open position independently of one another.

For example, the two orientable flaps are controlled by two separate actuators or linkages.

Preferably, it is possible to provide several groups of flaps, the flaps of one and the same group moving at the same time, while the groups pivot independently of one another.

Thus, it is possible to select certain flaps to generate the air flow and to target the aeration of certain zones of the engine compartment of the vehicle.

It will also be noted that the ventilation device according to the invention can be disposed at the front face of the motor vehicle in order to manage the air passing into the motor vehicle.

1. A ventilation device configured to generate an air flow in the direction of a motor vehicle heat exchanger, comprising:
ducts spaced-apart from each other; and
at least one air manifold having orifices,
each duct leading at one of its extremities into a separate orifice of the air manifold, each duct being provided with at least one opening for ejecting an air flow passing through said duct, the opening being separate from the extremities thereof and situated outside the air manifold, and
at least one duct being mounted so as to be orientable between a closed position and an open position, the device being configured to allow more air to pass through in the open position than in the closed position.

2. The device as claimed in claim 1, wherein at least two ducts are mounted in an orientable manner and are configured to be transferred into the closed position and into the open position independently of one another.

3. The device as claimed in claim 1, wherein all the ducts are mounted in an orientable manner.

4. The device as claimed in claim 3, wherein the ducts are positioned relative to one another so as to block an air flow in the closed position and so as to allow an air flow to circulate in the open position.

5. The device as claimed in claim 1, wherein the ducts are substantially rectilinear tubes that are mutually parallel and aligned so as to form a row of tubes.

6. The device as claimed in claim 1, which comprises means for controlling the orientation of each orientable duct .

7. The device as claimed in claim 6, wherein the control means comprise an actuator and/or a linkage.

8. The ventilation device as claimed in claim 1, wherein each duct has a section comprising:
a leading edge,
a trailing edge on the opposite side from the leading edge,
a first and a second profile that each extend between the leading edge and the trailing edge,
said at least one opening in the duct being in one of the first and second profiles, said at least one opening being configured such that an air flow exiting the opening flows along at least a portion of said one of the first and second profiles.

9. The device as claimed in claim 1, which also comprises, on at least one duct, an overmolded lip configured to come, in the closed position, into contact with an adjacent duct.

10. A heat exchange module for a motor vehicle, comprising:
a ventilation device comprising:
ducts spaced-apart from each other, and
at least one air manifold having orifices,
each duct leading at one of its extremities into a separate orifice of the air manifold,
each duct being provided with at least one opening for ejecting an air flow passing through said duct, the opening being separate from the extremities thereof and situated outside the air manifold, and
at least one duct being mounted so as to be orientable between a closed position and an open position, the device being configured to allow more air to pass through in the open position than in the closed position; and
a heat exchanger, the ventilation device and the heat exchanger being positioned relative to one another such that an air flow set in motion by the ventilation device supplies the heat exchanger with air.

11. A ventilation device configured to generate an air flow in the direction of a motor vehicle heat exchanger, comprising:
a plurality of ducts, substantially rectilinear, mutually parallel, and aligned so as to form a row of aerodynamic tubes spaced-apart from each other; and
at least one air manifold having orifices,
each aerodynamic tube leading at one of its extremities into a separate orifice of the air manifold,
each tube being provided with at least one opening for ejecting an air flow passing through said tube, the opening being separate from the extremities thereof and situated outside the air manifold, and
the aerodynamic tubes being mounted so as to be orientable between a closed position and an open position, the ventilation device being configured to vary the flow rate of air that passes through each air inlet in which the ventilation device is mounted and that arrives at the heat exchanger, based on the orientation of the orientable tubes.
